(19) United States
(12) Patent Application Publication
(10) Pub. No.: US 2019/0061913 A1
(43) Pub. Date: Feb. 28, 2019

(54) DOUBLE PITCH ANGLE PROPELLERS

(71) Applicant: Ali CAVUSOGLU, Nilufer/Bursa (TR)

(72) Inventor: Ali CAVUSOGLU, Nilufer/Bursa (TR)

(21) Appl. No.: 16/079,044

(22) PCT Filed: May 20, 2017
(86) PCT No.: PCT/TR2017/000061

§ 371 Date: Aug. 22, 2018

(30) Foreign Application Priority Data
Jun. 29, 2016 (TR) 2016/09143

(51) Int. Cl. B64C 11/18; B63H 1/28; B63H 1/20; B64C 11/10; B64C 11/20

(52) U.S. Cl. CPC B64C 11/18; B63H 1/28; B64C 11/20; B64C 11/10; B63H 1/20

(57) ABSTRACT

Disclosed is a design for high efficiency double pitch angle propellers, having a propeller hub, and two or more propeller blades with airfoil-shaped cross-section fixed around the periphery of the hub at equal angles. The blades have a geometric pitch angle together with the rotation direction as well as a second pitch angle that forms an acute angle or a wide angle with respect to the rotation axis, from its frontal side. The advantage of the second pitch angle is that it has no torque effect on the motor as there is not any force component on the rotation direction. Therefore for the additional pitch obtained from the second pitch angle. The propeller does not attract extra energy from the motor.

### TECHNICAL FIELD

The present invention relates to double-pitch propellers which, in addition to the geometric pitch angle, are perpendicular to this angle, not forming force and torque in the rotational force having a second pitch angle. The second pitch angle not forming a torque in the propellers rotated by a motor provides higher efficiency compared to a conventional propeller.

### BACKGROUND OF THE TECHNIQUE

The propeller blades generally have aerofoil shaped surfaces creating low pressure on one side, and high pressure on the other side. These surfaces create an angle to the direction of rotation so that the geometric pitch is formed. This angle is known as the ‘geometric pitch angle’. In this way a pressure difference is created on the front and back surfaces when the propeller rotates.

In this patent, the side of the propeller where low pressure is formed is described as the ‘front’ and the side where high pressure is formed, as the ‘back’.

The larger the geometric pitch angle is, the distance of the propeller and fluid relative to each other will be as much with each rotation of the propeller. Therefore a high propeller pitch increases the performance, which is a desired condition.

### Technical Problem

Although the increase of the geometric pitch angle increases the performance; the torque required to rotate the propeller also increases. This is because the geometric pitch angle is the angle formed by the direction of rotation. The forces formed on the blade surface create a force in the opposite direction of the direction of rotation at the sine rate of this angle. This force creates a torque load effect for the motor. In this case more energy is required to rotate the propeller. This, being an undesired situation, is a problem this invention aims to solve.

### Solution of the Problem

In propellers with double pitch angles, a second pitch angle exists in addition to the geometric pitch angle. The second pitch angle is the angle formed according to the rotation axis of the blade surfaces. The forces created on the blade surface are in the frontal direction in the second pitch angle sinus rate and in the central direction in the cosine rate. No force is created in the rotational direction. Therefore it does not have a torque effect on the motor. This forms the basis of the invention.

Second pitch angle feature; although a direct pitch angle does not exist; it creates an additional pitch according to the angle formed in line with the rotation axis of the fluid on the blade surface.

Whereby the torque effect of the motor is reduced by decreasing the geometric pitch angle for propellers with double pitch angle, at the same time performance in total pitch rate is obtained together with the additional pitch obtained by using the second pitch angle. In this way, higher yield is obtained compared with conventional propellers.

The details of the invention may be easier to understand with the help of non-limiting figures given as example.

### DESCRIPTION OF THE FIGURES

FIG. 1: Front view of a leaned forward, double pitch angle propeller

FIG. 1A: View of the A-A section of the propeller blade in FIG. 1.

FIG. 2: Side view of the propeller in FIG. 1.

FIG. 3: Top view of the propeller in FIG. 1.

FIG. 4: An example of the leaned forward propeller with the representative drawing of the linear path of fluid and the path according to the propeller.

FIG. 4A: A-A section of the propeller blade in FIG. 4, geometric pitch angle of the blade and the equivalent pitch angle representative drawing formed according to the relative path followed by the pitch angle and the fluid.

FIG. 5: Front view of a leaned backward double pitch angle propeller with blades starting from the hub and convex curved towards the tip.

FIG. 5A: A-A section view of the propeller blade in FIG. 5.

FIG. 5B: B-B section view of the propeller blade in FIG. 5.

FIG. 6: Side view of the propeller in FIG. 5.

FIG. 7: Top view of the propeller in FIG. 5.

FIG. 8: An example of application of the leaned backward propeller with the representative drawing of the linear path of fluid and the path according to the propeller.

FIG. 9: Top view of the propeller in FIG. 8, geometric pitch angle of the blade and the equivalent pitch angle representative drawing formed according to the relative path followed by the pitch angle and the fluid.

### REFERENCE NUMBERS

In Leaned Forward Propellers:
1 Propeller blade
1a Airfoil
2 Propeller hub
ϕ Second pitch angle
θ Incidence angle of the fluid towards the propeller

In Leaned Backward Propellers:
6 Propeller blade
6a Airfoil
6b Airfoil of which arch is increased
6c Blade surface with lower pressure
7 Propeller hub
ϕ1 Second pitch angle
θ1 Incidence angle of the fluid towards the propeller

Common References:
3 Rear side of the airplane
4 The track wherein the fluid flows
5 The track wherein the fluid flows in accordance with the propeller
8 Front side of the airplane
α Geometrical pitch angle
β Equivalent pitch angle
Ra Rotational axis
Rd Rotational direction
Δl Distance that the fluid covers on the blade surface
Δa Distance constituted by the geometrical angle of pitch
Δd Distance constituted by the second angle of pitch

### DETAILS OF THE INVENTION

This invention relates to high efficiency double pitch angle propellers, and is characterized in that it has a propeller hub (2, 7) connecting the propeller to the motor shaft; and two or more propeller blades (1, 6) with aerofoil-shaped cross-section (1a, 6a) fixed around the periphery of the said hub at equal angles.

The propeller blades are characterized in that the blade have a geometrical pitch angle (α) together with the rotation direction (Rd) and a as well as a second pitch angle (ϕ, ϕ1) that forms an acute angle (ϕ) or a wide angle (ϕ1) with respect to the rotation axis (Ra), from its frontal side.

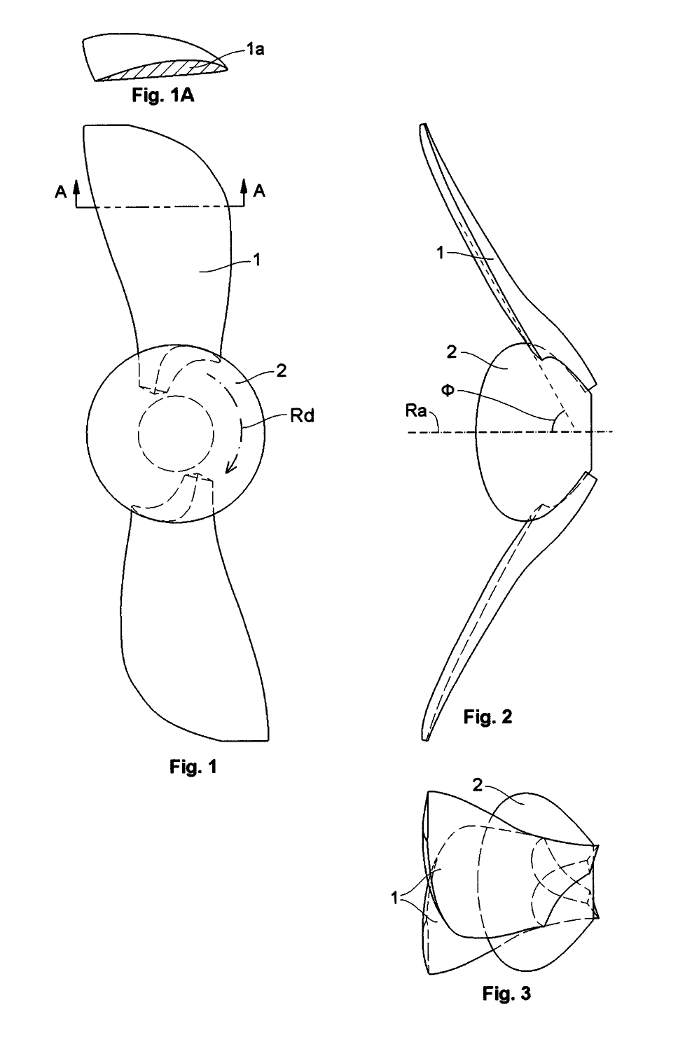

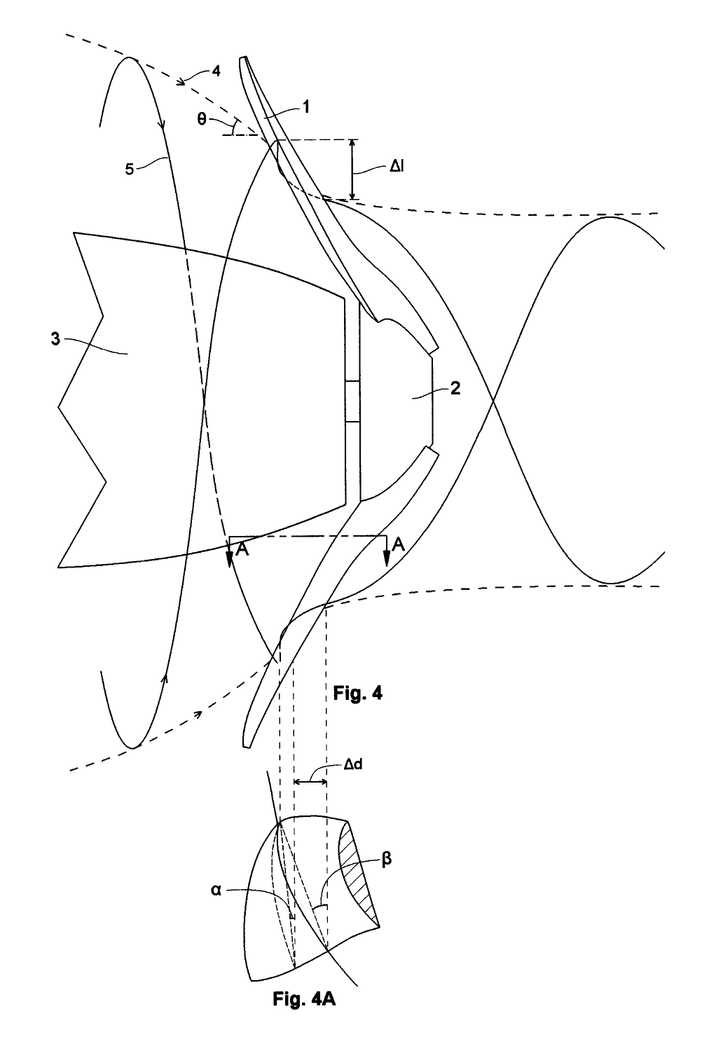

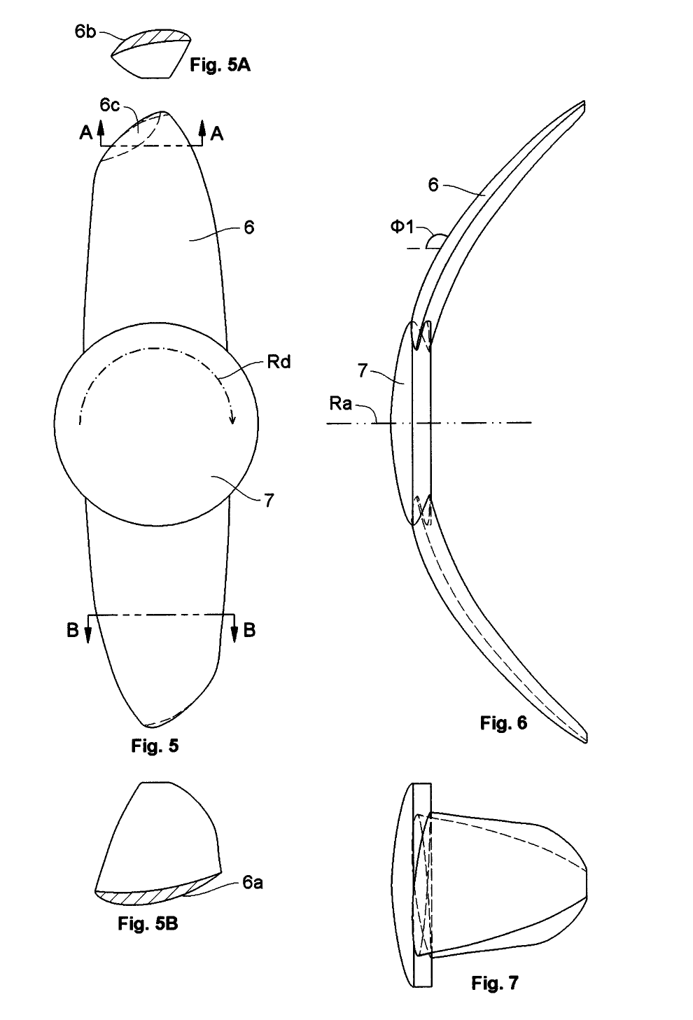

This second pitch angle is referred to as ‘leaned forward’ propellers (FIGS. 1, 2, 3 and 4) in case of acute angle (ϕ), and ‘leaned backwards’ propellers (FIGS. 5, 6, 7, 8 and 9) in case of wide angle (ϕ1).

The force of the second pitch angle (ϕ, ϕ1) is characterized in that the forces formed on the blade surfaces are in central direction at the rate of cosine, in the direction of the rotation axis (Rd) of the said sinus rate.

The advantage of the second pitch angle (ϕ, ϕ1) is that; it has no torque effect on the motor as there is not any force component on the rotation direction (Rd). Therefore for the additional pitch obtained from the second pitch angle; the propeller does not attract extra energy from the motor.

Although the second pitch angle (ϕ, ϕ1) is not a direct pitch angle, it is characterized in that; the fluid forms additional pitch in the distance rate it moves in the centre direction (Δl) on the blade surface and the angle of incidence of the blade surface.

The centre direction movement of the fluid on the blade surface depends on two effects. The first effect is the angle of incidence (θ, θ1) of the propeller according to the rotation axis (Ra) of the fluid and the second effect is the difference in pressure between the section of the blade close to the centre and the tip section.

The fluid (4) exits from the trailing edge by covering a distance in the centre direction (Δl) upon arriving to the propeller blade from the leading edge with a certain angle (θ, θ1) according to the rotation axis.

Meantime the fluid covers a distance from the front to the back in the rotation axis (Ra) direction.

A section (Δa) of this distance is created by the geometric pitch angle (α) and the other section (Δd), by the second pitch angle (ϕ, ϕ1).

The multiplication of the second pitch angle (ϕ, ϕ1) cosine with the distance (Δl) covered by the fluid in the centre direction makes up this distance (Δd) created by the second pitch angle (ϕ, ϕ1).

As a result of one turn of the propeller, additional pitch is created in the amount of the total of these distances (Δd) created by the second pitch angle (ϕ, ϕ1). This additional pitch is characterized in that; it has no torque effect and that it does not require extra energy from the motor for this.

The total pitch is the sum of the geometric pitch and the additional pitch so that ‘equivalent pitch’ and the angle creating this are also referred to as ‘equivalent pitch angle’ (β).

In this way, higher efficiency is obtained than with conventional propellers.

The purpose of this invention; is to reduce the geometric pitch angle (α) with a torque effect on the motor as much as possible; whereas to increase the equivalent pitch angle (β) by using the second pitch angle (ϕ, ϕ1) without any torque effect on the motor as much as possible.

For the forward leaning propellers (FIG. 1, 2, 3, 4), the fluid is required to flow from the outer section towards the centre with an angle (θ) according to the rotation axis (Ra) and the movement towards this centre while passing from the blade is required to be supported in order to benefit from the second pitch angle (ϕ).

In order to ensure that this condition is met for forward leaning propellers (FIG. 1, 2, 3, 4);
a) the propeller hub (2) is characterized in that; it is preferably water drop-shaped and that the blades are fixed to this hub from the back section;
b) the propeller blades (1) are characterized in that; in order to create lower pressure in the sections close to the centre than other sections, the geometric pitch in these sections is greater.

For backward leaning propellers (FIG. 5, 6, 7, 8, 9), the fluid is required to flow from the centre towards the outer section with an angle (θ1) according to the rotation axis (Ra) and the movement from the centre towards the outer section while passing from the blade is required to be supported in order to benefit from the second pitch angle (ϕ1).

In order to ensure that this condition is met for backward leaning propellers;
a) the propeller hub (7) is characterized in that; it has a convex curved form in order to guide the fluid from the centre towards the blade surface;
b) the propeller blades (6) are characterized in that; the geometric pitch is increased to create a lower pressure on the blade tip and/or the convex curve of airfoil (6b) is increased to create a lower pressure area (6c) at the trailing edge part on the blade tip, with respect to other sections.

The backward leaning propeller blades are preferably convex curved from the centre to the tip. The low pressure formed at the tip of the blades, also creates low pressure at the sections close to the tip by supporting the movement of the fluid from the centre outwards. This effect spreads all over the blade surface by chaining throughout the curved blade surface.

### Implementation of the Invention

The double pitch propellers can be used for such purposes as a lifting propeller for objects taking off vertically and as ventilation; as a propeller that makes the vehicle move for aerial vehicles such as a plane, paramotor and water crafts such as ships. It provides increased yield and saves energy in the fields used.

The flow of the fluid from outside to the centre towards the propeller increases the efficiency in the forward leaning propellers (FIG. 4). Therefore in case a propeller is installed to the back section (3) of the plane in the implementation as an example, the entire plane body forms a water drop shape and the back section supports the air flow (4) from the outside to the centre.

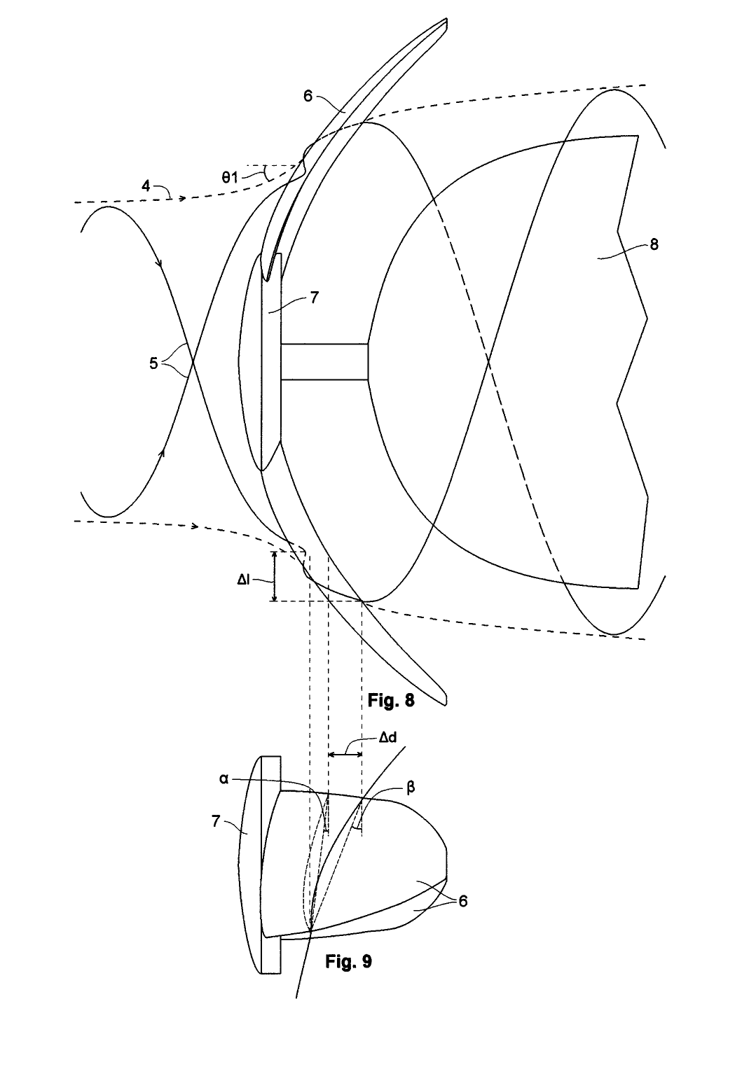

The flow of the fluid from the centre outwards, towards the propeller increases the efficiency in the forward leaning propellers (FIGS. 8 and 9). Therefore in case a propeller is installed to the front side (8) of the plane in the implementation as an example, the entire plane body forms a water drop shape and the front section supports the air flow (4) from the outside to the centre.

Therefore the forward leaning propellers are more suitable to be used as ‘propulsive propeller’, whereas the backwards leaning propellers as ‘pulling propellers’. The forward leaning propellers may be preferred for vertically taking off objects and low speed implementations.

1- Double pitch angle propellers have two models with leaned forward and leaned backward,
The leaned forward double pitch angle propeller comprises a propeller hub (2) providing the propeller connection to motor shaft, two or more propeller blades (1) in shape of airfoil (1a) with transverse section which is fixed in an equiangular way around the propeller hub and,
The leaned backward double pitch angle propeller comprises a propeller hub (7), two or more propeller blades (6) in shape of airfoil (6a) with transverse section which is fixed in an equiangular way around the propeller hub.

2- The leaned forward double pitch angle propeller according to claim 1 wherein said the propeller blades (1) surfaces have geometrical pitch angle (α) with rotational direction (Rd) and a acute angled from the front side second pitch angle (ϕ) with the rotation axis (Ra).

3- The leaned backward double pitch angle propeller according to claim 1 wherein said the propeller blades (6) surfaces have rotational direction (Rd) with geometrical pitch angle (α) and a wide angle from the front side second pitch angle (ϕ1) with the rotational axis (Ra).

4- The leaned forward double pitch angle propeller according to claim 1 wherein said the propeller blades (1) is characterized in that; the geometrical pitch which is close to hub (2) is more than the other parts so that it creates lower pressure in front of blades close to hub (2) section and it supporting the movement of the fluid (4) towards the center.

5- The leaned backward double pitch angle propeller according to claim 1 wherein the propeller blades (6) is characterized in that; the geometrical pitch which is propeller tip part is increased so that it creates lower pressure in front of blades tip and if supporting the movement of the fluid (4) outwards from the center.

6- The leaned forward double pitch angle propeller according to claim 1 wherein said the propeller hub (2) characterized in that; it has a aerodynamic form similar to water drop and propeller blades (1) fixed to the propeller hub (2) from rear side thereof so it supporting the movement of the fluid (4) towards the center which is close to hub section.

7- The leaned forward double pitch angle propeller according to claim 2 wherein said the second pitch angle (ϕ) is characterized with the advantage that; this angle plain is perpendicular with rotational direction (Rd) so it does not cause any force in the rotational direction and it does not affect the motor which rotates the propeller as a torque in a negative way.

8- The leaned forward double pitch angle propeller according to claim 2 wherein said the second pitch angle (ϕ) is characterized in that; this angle from front to backward creates a leaned blade surface so fluid when moving from outside to inside creates an fluid angle (θ) with rotation axis (Ra) and a distance (Δl) from outside to inside on the blade surface that, those angles (ϕ, θ) create a distance (Δd) from front to backward that, it constitutes non-torque an extra pitch in addition to geometrical pitch.

9- The leaned backward double pitch angle propeller according to claim 3 wherein said the second pitch angle (ϕ1) is characterized with the advantage that; this angle plain is perpendicular with rotational direction (Rd) so it does not cause any force in the rotational direction and it does not affect the motor which rotates the propeller as a torque in a negative way.

10- The leaned backward double pitch angle propeller according to claim 3 wherein said the second pitch angle (ϕ1) is characterized in that; this angle from front to backward creates a leaned blade surface so fluid when moving from inside to outside creates an fluid angle (θ1) with rotation axis (Ra) and a distance (Δl) from inside to outside on the blade surface that, those angles (ϕ1, θ1) create a distance (Δd) from front to backward that, it constitutes non-torque an extra pitch in addition to geometrical pitch.
